(19) United States
(12) Patent Application Publication
(10) Pub. No.: US 2024/0296467 A1
(43) Pub. Date: Sep. 5, 2024

(54) PURCHASE DATA ANALYSIS APPARATUS, METHOD AND STORAGE MEDIUM

(71) Applicant: KABUSHIKI KAISHA TOSHIBA, Tokyo (JP)

(72) Inventors: Yoshiaki MIZUOKA, Kamakura Kanagawa (JP); Kouta NAKATA, Chigasaki Kanagawa (JP)

(73) Assignee: KABUSHIKI KAISHA TOSHIBA, Tokyo (JP)

(21) Appl. No.: 18/488,878

(22) Filed: Oct. 17, 2023

(30) Foreign Application Priority Data
Mar. 1, 2023 (JP) 2023-031354

(51) Int. Cl. G06Q 30/0201

(52) U.S. Cl. CPC G06Q 30/0201

(57) ABSTRACT

A purchase data analysis apparatus includes processing circuitry. The processing circuitry is configured to: acquire, on a customer-by-customer basis, customer information including an action time of a purchase-related action relating to purchase; generate, on a customer-by-customer basis, a customer representation representing an action pattern of a customer, based on the action time; generate, on a store-by-store basis, a store representation representing a representation of a customer coming to a store, based on the customer representation; and cluster stores by using the store representation.

### CROSS-REFERENCE TO RELATED APPLICATION

This application is based upon and claims the benefit of priority from prior Japanese Patent Application No. 2023-031354, filed Mar. 1, 2023, the entire contents of which are incorporated herein by reference.

### FIELD

Embodiments described herein relate generally to a purchase data analysis apparatus, method and storage medium.

### BACKGROUND

A purchase data analysis apparatus is used for analyzing purchase history data to which IDs of customers are added, such as ID-POS data. Recently, purchase history data over a plurality of stores or a plurality of companies has been obtainable through a settlement system or a point system. It is thus required to cluster (classify) a set of stores into a plurality of sets with similar characteristics (hereinafter referred to as “store clusters”) and to analyze the stores by using the clustering result, by using a clustering method of classifying a plurality of data into a plurality of sets with similar representations.

For the clustering of stores, information such as a sales time, sales proceeds and commodity sales is used. However, since the information such as commodity sales depends on merchandise assortment in stores, stockout in stores, sales methods in stores, and so forth, the result of the clustering of stores reflects differences in merchandise assortment, stockout and sales methods in stores, and can hardly appropriately reflect the characteristics of stores. For example, in a case where merchandise assortment is different between stores and the number of common commodities is small, it is difficult to obtain a proper clustering result by the clustering of stores using commodity sales. Thus, in the clustering of stores using only the sales time and sales proceeds, the amount of information for clustering stores is small, and it is difficult to appropriately cluster stores.

In addition, in the analysis of stores using the clustering result of stores, a sales prediction of commodities is performed by using a statistical method or a machine learning method. For example, a sales prediction is performed by using a sales history of commodities in the past. In a case of performing a sales prediction of commodities that are not currently handled in a certain store, use is made of a past sales history in another store belonging to the same store cluster. At this time, if stores with similar characteristics are not appropriately classified, and sales histories of stores with different characteristics are used, an accurate sales prediction cannot be expected. It is thus important to obtain a store cluster in which stores or companies with similar characteristics are appropriately classified. Note that an analysis result of stores can be utilized for an analysis of a company including one or more stores.

### BRIEF DESCRIPTION OF THE DRAWINGS

FIG. 1 is a diagram illustrating an example of a configuration of a purchase data analysis apparatus according to an embodiment.

FIG. 2 is a flowchart exemplarily illustrating a processing procedure of an analysis process by the purchase data analysis apparatus according to the embodiment.

FIG. 3 is a diagram illustrating an example of customer representations.

FIG. 4 is a diagram illustrating an example of customer representations.

FIG. 5 is a diagram illustrating an example of customer representations.

FIG. 6 is a diagram illustrating an example of a clustering result of customers.

FIG. 7 is a diagram illustrating an example of store representations.

FIG. 8 is a diagram illustrating an example of a clustering result of stores.

FIG. 9 is a schematic diagram schematically illustrating a flow of processing in an analysis process.

FIG. 10 is a view illustrating an example of a display screen displayed in a case where a store cluster is designated.

FIG. 11 is a view illustrating an example of a display screen displayed in a case where a store is designated.

FIG. 12 is a view illustrating an example of a display screen displayed in a case where a commodity is designated.

FIG. 13 is a view illustrating an example of a display screen that accepts an input of a name and information of a store cluster.

FIG. 14 is a view illustrating an example of a display screen that accepts an input of a name and information of a store cluster label.

FIG. 15 is a diagram illustrating an example of data stored in a store cluster label storage unit.

FIG. 16 is a diagram illustrating an example of data stored in the store cluster label storage unit.

FIG. 17 is a diagram illustrating an example of data stored in the store cluster label storage unit.

FIG. 18 is a diagram for concretely describing advantageous effects of the purchase analysis apparatus of the embodiment.

FIG. 19 is a schematic diagram schematically illustrating a flow of processing in an analysis process according to a modification.

FIG. 20 is a block diagram exemplarily illustrating a hardware configuration of a purchase data analysis apparatus according to an applied example.

### DETAILED DESCRIPTION

In general, according to one embodiment, a purchase data analysis apparatus includes processing circuitry. The processing circuitry is configured to: acquire, on a customer-by-customer basis, customer information including an action time of a purchase-related action relating to purchase; generate, on a customer-by-customer basis, a customer representation representing an action pattern of a customer, based on the action time; generate, on a store-by-store basis, a store representation representing a representation of a customer coming to a store, based on the customer representation; and cluster stores by using the store representation.

Hereinafter, referring to the accompanying drawings, embodiments of a purchase data analysis apparatus, method and storage medium are described in detail. In the description below, structural elements having substantially identical functions and structures are denoted by identical reference signs, and an overlapping description is given only where necessary.

### Embodiments

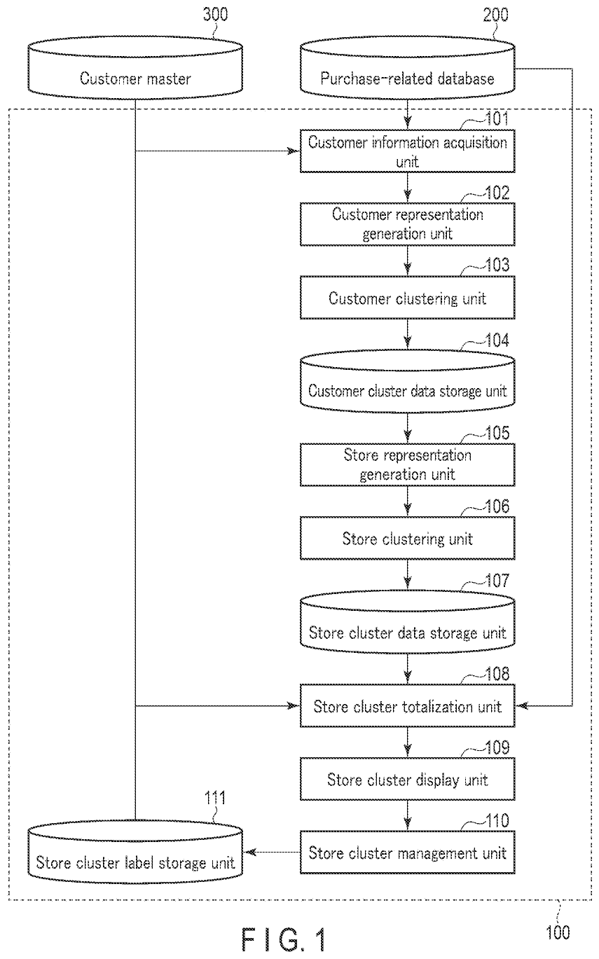

FIG. 1 is a diagram illustrating a configuration of a purchase data analysis apparatus 100 according to an embodiment. The purchase data analysis apparatus 100 is an apparatus used for analyzing purchase data. The purchase data analysis apparatus 100 is connected, via a network or the like, to a purchase-related database 200 that stores purchase-related data, and a customer master 300 that stores information of customers. The network is, for example, a LAN (Local Area Network). Note that the connection to the network may be either wired connection or wireless connection. In addition, the network is not limited to the LAN, and may be the internet, a public communication line, or the like.

The purchase-related database 200 stores purchase-related data. The purchase-related data is customer information including an action time of a purchase-related action relating to purchase. The purchase-related data includes purchase data to which an ID of a customer (hereinafter referred to as “customer ID”) is added. The purchase data to which the customer ID is added is, for example, ID-POS data. In the purchase-related data, each customer included in the purchase data can be distinguished by using the ID. The purchase data includes time information of a purchase-related action. The time information is an action time of the purchase-related action. The purchase-related action is an action relating to purchase. The purchase-related action is, for example, an action such as settlement, coming to a store, or taking a commodity in a hand. A settlement time can be acquired, for example, from information of a receipt or a point card. A time of coming to a store can be acquired, for example, from an in-store camera installed in the store. A time of taking a commodity in a hand can be acquired, for example, from ID-POS data of an automatic settlement store. Note that in a case of using image information of an in-store camera or the like, it is possible to specify a person and distinguish a customer by using a face recognition technology or the like on images.

The customer master 300 stores customer master data. The customer master data is information relating to customers. The customer master data includes, for example, an age, an age bracket, a gender, an address, favorite food, favorite topics, and the like of each of customers. The customer master data is, for example, information acquired from membership registration information, input information of a questionnaire, and various analysis results.

The purchase data analysis apparatus 100 includes a customer information acquisition unit 101, a customer representation generation unit 102, a customer clustering unit 103, a customer cluster data storage unit 104, a store representation generation unit 105, a store clustering unit 106, a store cluster data storage unit 107, a store cluster totalization unit 108, a store cluster display unit 109, a store cluster management unit 110, and a store cluster label storage unit 111.

The customer information acquisition unit 101 acquires purchase-related data on a customer-by-customer basis. The purchase-related data is acquired, for example, from the purchase-related database 200. At this time, the customer information acquisition unit 101 may acquire only the information used for generating customer representations (to be described later), among pieces of information stored in the purchase-related database 200, or may acquire all data. In addition, in a case where the customer master data is necessary for generating customer representations, the customer information acquisition unit 101 further acquires necessary customer master data. The customer master data is acquired, for example, from the customer master 300.

Note that the customer information acquisition unit 101 may acquire only data corresponding to the designation of a condition. For example, the customer information acquisition unit 101 may acquire only purchase-related data acquired in a designated acquisition period, or may acquire only purchase-related data corresponding to the designation of the category of business of a store. Besides, in accordance with the designation of the age bracket of customers by a user, the customer information acquisition unit 101 may acquire only purchase-related data of customers of the corresponding age bracket.

The customer representation generation unit 102 generates, on a customer-by-customer basis, customer representations representing an action pattern and a habit of the customer, based on action times included in the acquired purchase-related data. At this time, the customer representation generation unit 102 generates, in regard to each of stores, customer representations relating to each customer that used the store, on a customer-by-customer basis. In other words, the customer representation generation unit 102 representation-quantizes customers by using the time information of the purchase-related actions acquired by the customer information acquisition unit 101. The action pattern of the customer is, for example, a habit relating to the purchase-related action of the customer. As the customer representations, use is made of a periodic explanatory variable, an elapsed time from the entry to the store to the purchase-related action, and the like.

The customer clustering unit 103 clusters each customer, based on the customer representations. At this time, the customer clustering unit 103 executes, in regard to each of stores, clustering of the customers included in the purchase-related data of the store by using the customer representations, and classifies the customers into a plurality of customer clusters. For the clustering of customers, use can be made of an existing clustering method of classifying a plurality of data into a plurality of sets having similar representations. For example, a k-means method and a hierarchical method can be used, but the method is not limited to these. The customer clustering unit 103 stores the clustering result of each customer in the customer cluster data storage unit 104.

The customer cluster data storage unit 104 stores the clustering result relating to each customer. The clustering result is stored, for example, in a table format composed of a combination of columns of a customer ID, a store ID and a customer cluster ID.

The store representation generation unit 105 generates, on a store-by-store basis, store representations representing a tendency relating to action patterns or habits of customers coming to the store, based on the customer representations. For example, using the clustering result of each customer for which the customer representations are used, the store representation generation unit 105 calculates the number of customers belonging to each customer cluster on a store-by-store basis, and generates the calculation result as store representations.

The store clustering unit 106 clusters each store by using the store representations. At this time, the store clustering unit 106 executes clustering of stores, based on the store representations, and classifies the stores into a plurality of store clusters. For the clustering of stores, use can be made of an existing clustering method of classifying a plurality of data into a plurality of sets having similar representations. For example, a k-means method and a hierarchical method can be used, but the method is not limited to these. The store clustering unit 106 stores the clustering result of each store in the store cluster data storage unit 107.

The store cluster data storage unit 107 stores the clustering result for each store. The clustering result is stored, for example, in a table format composed of a combination of columns of a store ID and a store cluster ID.

The store cluster totalization unit 108 totalizes the purchase-related data in regard to each of store clusters, based on the clustering result of the stores. For example, the store cluster totalization unit 108 executes various kinds of totalization necessary for the store cluster display unit 109, based on the store clusters stored in the store cluster data storage unit 107 and the designation from the user. Note that the totalization for all items may be executed without the designation by the user.

For example, in a case where a store cluster is designated by the user, such totalization processes are executed, as acquisition of a list of stores belonging to the designated store cluster, totalization of a ratio, by age brackets, of demographic attributes such as ages and genders of customers coming to the stores belonging to the designated store cluster, calculation of an average value of customer representations of customers of the stores belonging to the designated store cluster, and totalization of numerical quantities and proceeds of commodity sales in the stores belonging to the designated store cluster. In addition, as a totalization process, a sales prediction of the designated store cluster may be executed for all commodities and each commodity, based on the sales result of the designated store cluster.

Additionally, in a case where a store is designated by the user, a totalization process, such as totalization of a commodity sales result of the designated store, is executed. For example, based on sales results of stores belonging to the store cluster to which the designated store belongs, a sales prediction of the designated store is executed for all commodities and each commodity.

Additionally, in a case where a commodity is designated by the user, such totalization processes are executed, as totalization of a sales result of the designated commodity in regard to each of store clusters, and totalization of a sales result of the designated commodity in regard to each of stores. Besides, as a totalization process, a sales prediction of the designated commodity may be executed in regard to each of store clusters. Note that in a case where the number of stores that are targets of totalization is large, the totalization process may be executed by limiting the stores to stores with great sales results of the designated commodity.

Furthermore, the totalization in regard to each of the store clusters may be executed by using the customer master data in addition to the purchase-related data. In this case, the store cluster totalization unit 108 executes the totalization using the purchase-related data and the customer master data in regard to each of the store clusters.

Additionally, the store cluster totalization unit 108 may execute the totalization of the purchase-related data in regard to each of store cluster labels, in addition to the totalization of the purchase-related data in regard to each of the store clusters. The store cluster label is a cluster group composed of one or more store clusters, and can freely be set by the user. Typically, the store cluster label is composed of a plurality of store clusters. The totalization in units of a store cluster label may be executed by a method that is similar to or different from the above-described totalization for each of the store clusters.

The store cluster display unit 109 displays the totalization result of the purchase-related data. The store cluster display unit 109 causes a display to display, for example, the totalization result obtained by the store cluster totalization unit 108, in accordance with an operation by the user. Note that the name of the store cluster, the information of the store cluster, the name of the store cluster label, the information of the store cluster label, and the like may be displayed on the display in addition to the totalization result.

The store cluster management unit 110 manages the store cluster and the store cluster label. For example, the store cluster management unit 110 accepts an input of the the name of the store cluster, the information of the store cluster, the name of the store cluster label, the information of the store cluster label, and the like, and stores the accepted name and information in the store cluster label storage unit 111. The data stored in the store cluster label storage unit 111 is read and used by the store cluster totalization unit 108 and the store cluster management unit 110.

The store cluster label storage unit 111 stores the name and information that are input by the store cluster management unit 110. For example, in a case where the input of the name of the store cluster or the name of the store cluster label is accepted by the store cluster management unit 110, the store cluster label storage unit 111 updates the stored name to the input name.

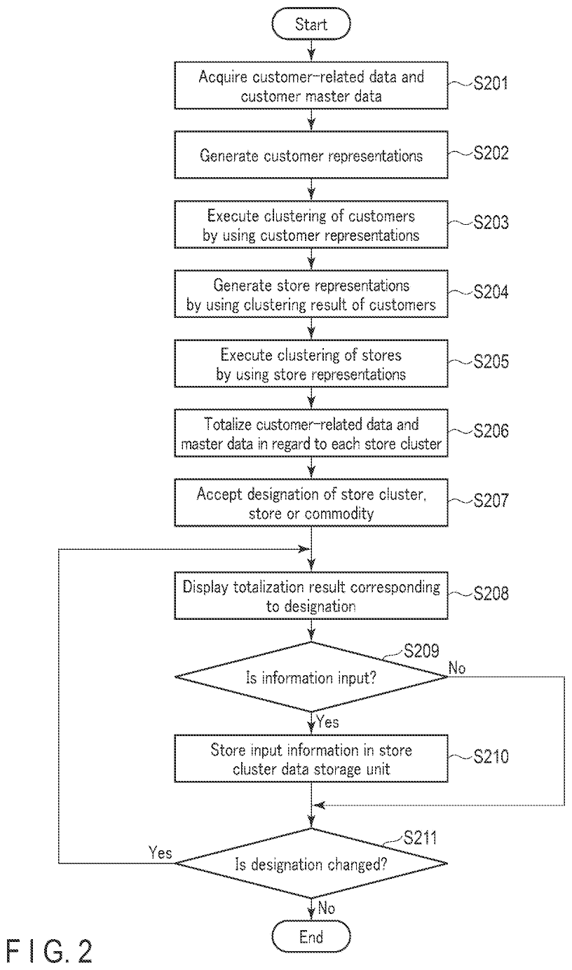

Next, a description is given of an operation of the clustering process that is executed by the purchase data analysis apparatus 100. FIG. 2 is a flowchart illustrating an example of the procedure of a clustering process executed by the purchase data analysis apparatus 100. The clustering process is a process of classifying a plurality of stores into a plurality of sets with similar characteristics, by using the purchase-related data of each of stores. Note that the processing procedure in each process described below is merely an example, and each process can be modified as appropriate as much as possible. In addition, as regards the processing procedure described below, steps can be omitted, replaced and added as appropriate in accordance with embodiments.

### (Clustering Process)

### (Step S201)

To start with, the customer information acquisition unit 101 acquires purchase-related data from the purchase-related database 200. The purchase-related data includes purchase data in a plurality of stores. In addition, the customer information acquisition unit 101 specifies a customer included in the purchase-related data, based on a customer ID included in the acquired purchase-related data, and acquires customer master data relating to the specified customer from the customer master 300.

### (Step S202)

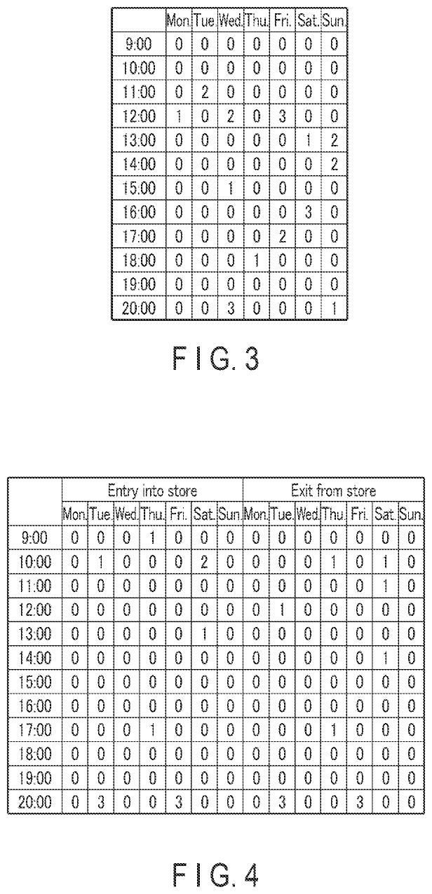

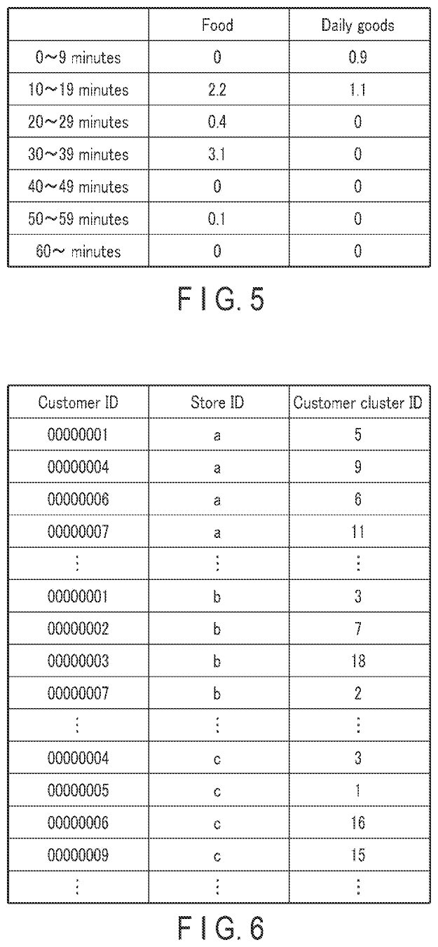

Next, based on the acquired purchase-related data, the customer representation generation unit 102 generates customer representations on a store-by-store basis. FIG. 3 to FIG. 5 are diagrams illustrating examples of customer representations. FIG. 3 to FIG. 5 illustrate customer representations of a specific customer coming to a specific store. In addition, in FIG. 3 to FIG. 5, customer representations are generated by using purchase-related data in one month. FIG. 3 and FIG. 4 illustrate examples in a case of using periodic explanatory variables as customer representations. The customer representations illustrated in FIG. 3 and FIG. 4 are also called “customer store-visiting pattern”. FIG. 5 illustrates an example in a case where an elapsed time from an entry into the store to a purchase-related action is used as a customer representation.

In FIG. 3, the number of times of settlement for each day of the week and for each one-hour time range is used as a customer representation, by using settlement times in one month as purchase-related times. The settlement times are acquired, for example, by using the information of receipts or point cards.

In FIG. 4, the number of times of entry into the store and the number of times of exit from the store for each day of the week and for each one-hour time range are used as customer representations, by using entry times and exit times in one month as purchase-related times. The entry times and exit times are acquired, for example, by using data acquired by a monitoring camera that photographs scenes of customers entering and exiting the store.

Note that in the examples of FIG. 3 and FIG. 4, the number of times of each purchase action in one month is utilized, but an average number of times in one day may be utilized. For example, an average value per day may be calculated and used by dividing each number of times in FIG. 3 and FIG. 4 by the number of days included in the month.

In FIG. 5, an elapsed time from the entry into the store to the taking of a commodity in the hand is calculated by using the entry time and the time of taking the commodity in the hand as purchase-related times, and the number of times of the elapsed time per ten minutes is used as a customer representation. The time of taking the commodity in the hand is acquired, for example, from ID-POS data of an automatic settlement store.

Besides, the customer representation generation unit 102 may generate the customer representations, based on the purchase-related data and the customer master data. For example, customer master data, such as the age, gender and liking, are acquired, and the added result of these data and the numerals in FIG. 3 to FIG. 5 may be used as customer representations.

### (Step S203)

Next, the customer clustering unit 103 executes clustering for each customer by using customer representations, and acquires a customer cluster ID of each customer as a clustering result. The acquired clustering result is in a table format composed of a combination of columns of a customer ID, a store ID and a customer cluster ID. The clustering result is stored in the customer cluster data storage unit 104. FIG. 6 is a diagram illustrating an example of a clustering result in regard to each of customers.

### (Step S204)

Next, using the clustering result of each customer, the store representation generation unit 105 generates store representations for each store. At this time, the store representation generation unit 105 generates, as a store-visiting representation, a distribution of customers belonging to each customer cluster ID.

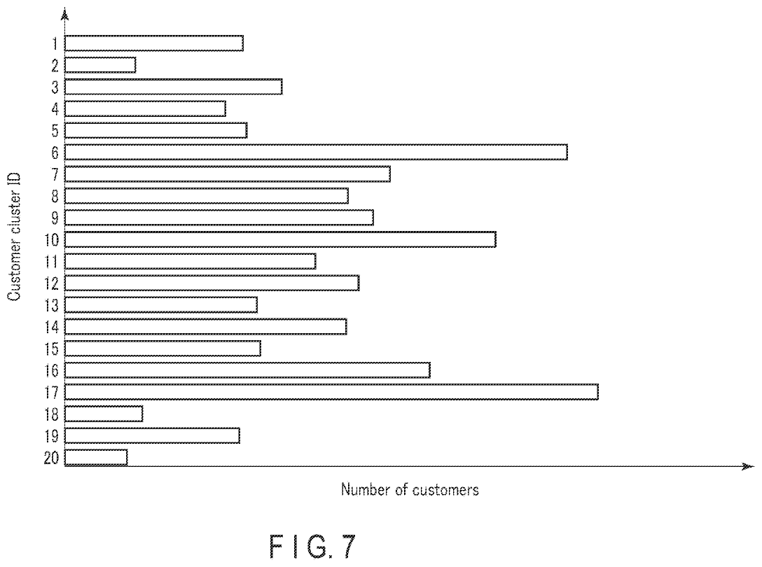

FIG. 7 is a diagram illustrating an example of store representations generated by using the clustering result of customers. FIG. 7 illustrates store representations of a specific store. In the example of FIG. 7, the number of customers for each customer cluster ID is used as a store representation. The ordinate axis of FIG. 7 indicates a customer cluster ID, and the abscissa axis indicates the number of customers belonging to each customer cluster ID. Note that, instead of the number of customers belonging to each customer cluster ID, use may be made of a ratio of each customer cluster to all customers of the store.

### (Step S205)

Next, the store clustering unit 106 executes clustering of stores on a store-by-store basis by using store-visiting representations, and acquires a store cluster ID of each store as a clustering result. The clustering result is stored in the store cluster data storage unit 107.

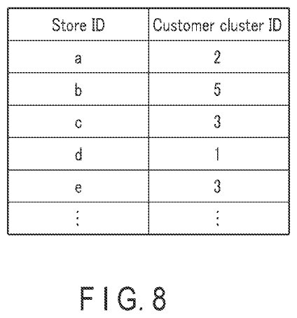

FIG. 8 is a diagram illustrating an example of a clustering result for each store. In the example of FIG. 8, the clustering result of stores is stored in a table format composed of a combination of a store ID and a store cluster ID.

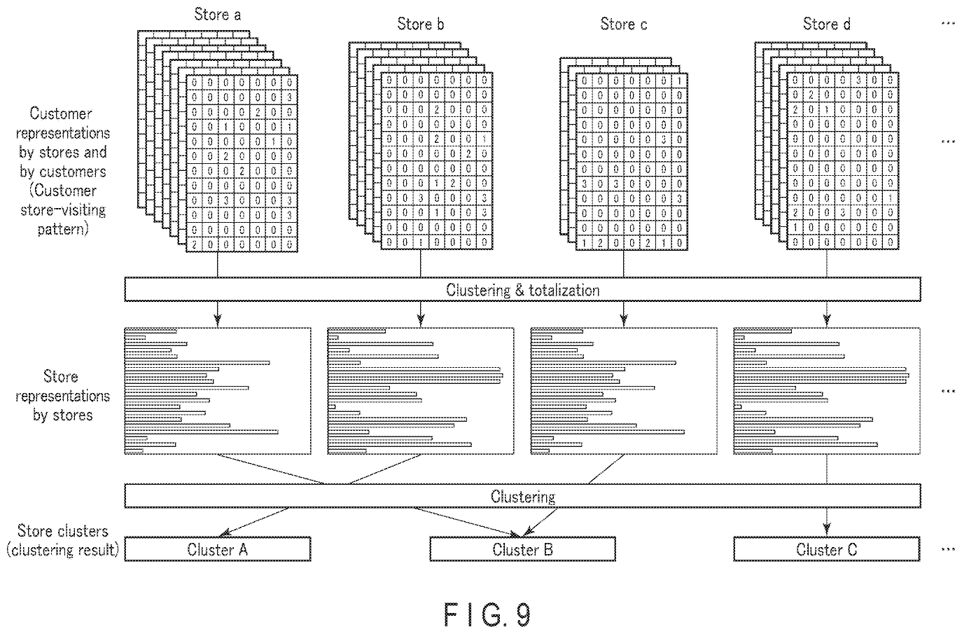

FIG. 9 is a schematic diagram schematically illustrating the content of the process from step S201 to step S205. As illustrated in FIG. 9, in the process from step S201 to step S205, the purchase data analysis apparatus 100 acquires customer representations of customers coming to each store, executes first clustering for customers by using the customer representations, and classifies the customers into customer clusters. Thereafter, the customer clusters obtained by the first clustering result are counted on a store-by-store basis, and the count results are set as store representations. Then, second clustering is executed by using the store representations, and the stores are classified into store clusters.

### (Step S206)

Next, the store cluster totalization unit 108 executes various kinds of totalization for the customer-related data and the customer master data, on a per-store-cluster basis or on a per-store-cluster-label basis. The the store cluster totalization unit 108 acquires necessary data for totalization from the purchase-related database 200 and customer master 300, and executes totalization by using the acquired data. At a time of executing the totalization, all preset items may be totalized, or only items designated by the user may be totalized.

### (Step S207)

Next, the store cluster display unit 109 accepts the designation of a store, a store cluster, a store cluster label, or a commodity. For example, a store is designated by the user inputting a store name or a store ID, a store cluster is designated by the user inputting a store cluster name or a store cluster ID, a commodity is designated by the user inputting a commodity name or a commodity ID, and a store cluster label is designated by the user inputting a store cluster label name or a store cluster label ID.

### (Step S208)

Next, the store cluster display unit 109 causes a display to display the totalization result relating to the designated store, store cluster or commodity.

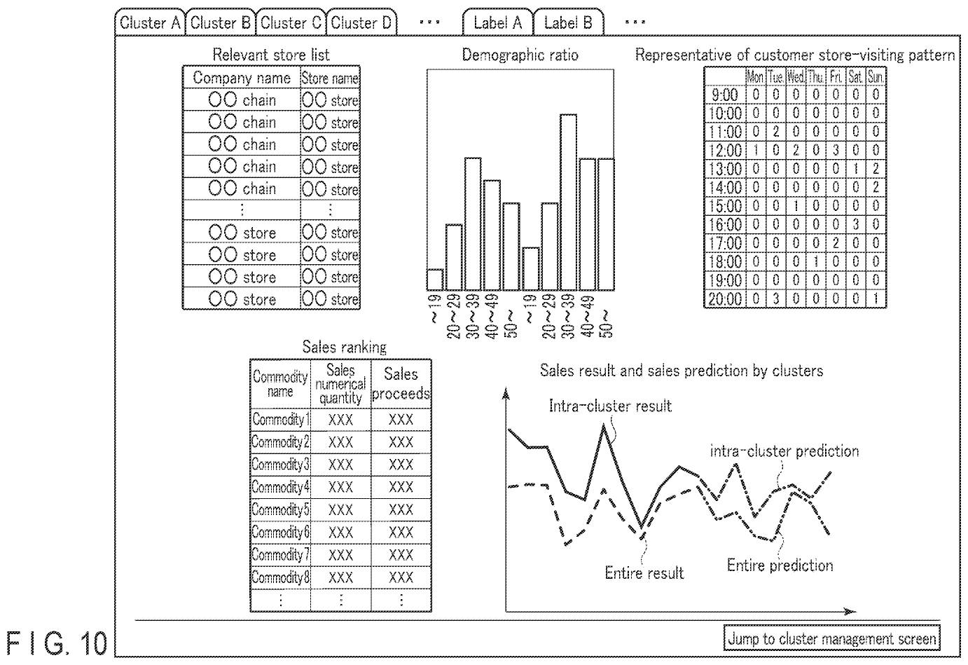

In a case where a specific store cluster is designated in step S207, the totalization result of the designated store cluster is displayed. FIG. 10 is a view illustrating an example of a display screen displayed in a case where a store cluster, which is named “cluster A”, is designated. In the example of FIG. 10, five items, namely “relevant store list”, “demographic ratio”, “representative of customer store-visiting pattern”, “sales ranking”, and “sales result and sales prediction by clusters”, are displayed as totalization results. Also in a case where a specific store cluster label is designated in step S207, the same items as in FIG. 10 may be displayed.

The “relevant store list” displays store names belonging to the store cluster of “cluster A”, and company names of the stores.

The “demographic ratio” displays a distribution of demographic attributes of customers coming to the stores belonging to the “cluster A”. Here, the gender and age bracket of customers are used as demographic attribute information, and the ratios of the numbers of times of store-visiting in age brackets are displayed separately for males and females.

The “representative of customer store-visiting pattern” displays a representative customer store-visiting pattern of customers coming to the stores belonging to the “cluster A”. For example, in the “representative of customer store-visiting pattern”, the numbers of customers coming to the stores belonging to the “cluster A” are totalized in regard to each of customer clusters, and a representative store-visiting pattern in a customer cluster with a largest number of customers is displayed.

The “sales ranking” displays, in a descending order of sales proceeds, the total of the sales numerical quantity and the total of the sales proceeds of each commodity in the stores belonging to the “cluster A”.

The “sales result and sales prediction by clusters” displays graphs indicating time-sequential variations of an “entire result of sales”, an “intra-cluster result of sales”, an “entire prediction of sales”, and an “intra-cluster prediction of sales”. The abscissa axis of each item indicates a date or a month, and the ordinate axis indicates proceeds. The “entire result of sales” is an average value of past sales proceeds in one store, with all stores being targets. The “intra-cluster result of sales” is an average value of past sales proceeds in one store, with the stores belonging to the “cluster A” being targets. The “entire prediction of sales” is an average value of future sales prediction proceeds in one store, with all stores being targets. The “intra-cluster prediction of sales” is an average value of future sales prediction proceeds in one store, with the stores belonging to the “cluster A” being targets.

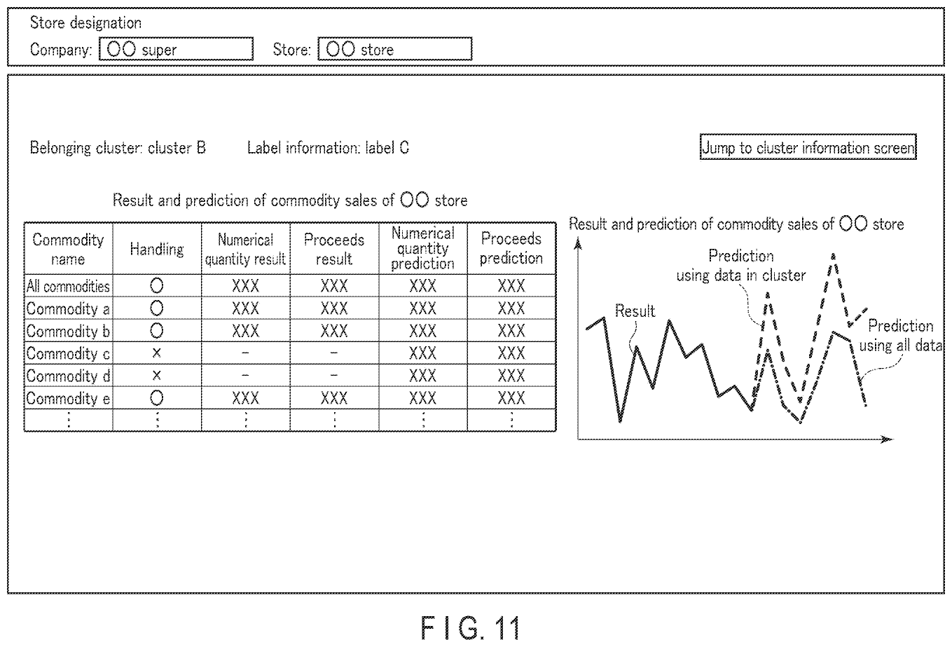

In addition, in a case where a specific store is designated in step S207, the totalization result of the designated store is displayed. FIG. 11 is a view illustrating an example of a display screen displayed in a case where a store, which is named “∘∘ store”, is designated. In the example of FIG. 11, the display screen displays a “store name”, a “company name of company operating ∘∘ store”, a “belonging cluster”, and a “totalization result relating to ∘∘ store”.

The “belonging cluster” displays the name of a store cluster to which the “∘∘ store” belongs. The totalization result displays two items, namely a “table of result and prediction of commodity sales” and “graphs of result and prediction of commodity sales”. The “table of result and prediction of commodity sales” displays a numerical quantity result, a proceeds result, a numerical quantity prediction and a proceeds prediction of commodity sales on a commodity-by-commodity basis. Here, not only the commodities handled in “∘∘ store”, but also the commodities handled in other stores of the store cluster to which the “∘∘ store” belongs, are displayed. The “graphs of result and prediction of commodity sales” display the total of the past sales of the “∘∘ store” and a time-sequential variation of predicted proceeds of future sales. In addition, as the predicted proceeds, both the predicted proceeds predicted based on the sales result of all stores, and the predicted proceeds predicted based on the sales proceeds of the stores belonging to the store cluster of the “cluster B” to which the “∘∘ store” belongs, are displayed.

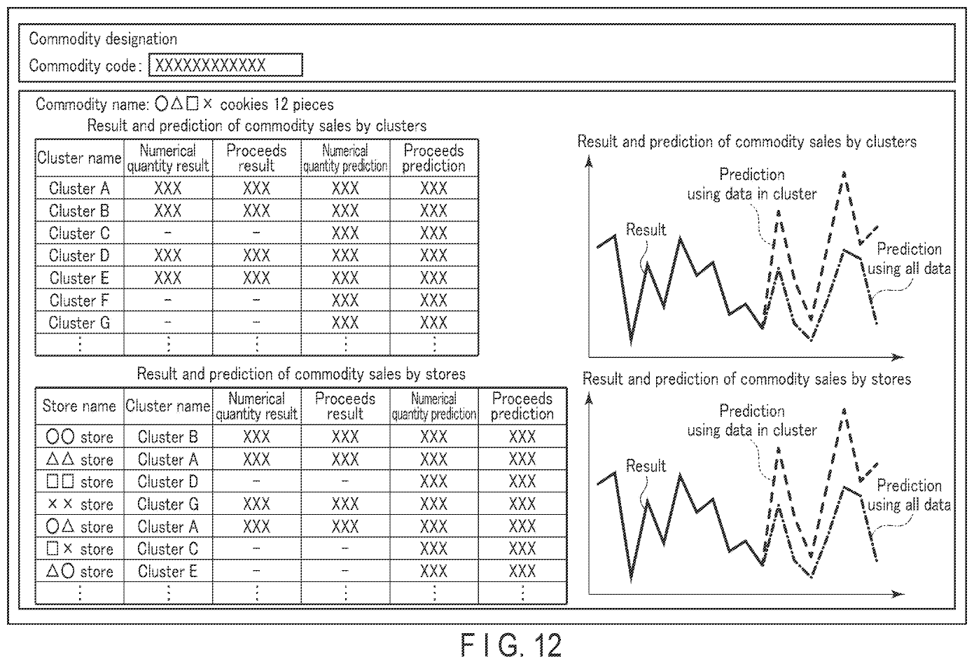

In addition, in a case where a specific commodity is designated in step S207, the totalization result of the designated commodity is displayed. FIG. 12 is a view illustrating an example of a display screen displayed in a case where a commodity, which has a commodity name “∘Δ□× cookies 12 pieces”, is designated. In the example of FIG. 12, as the totalization results, four items, namely a “table of result and prediction of commodity sales by clusters”, “graphs of result and prediction of commodity sales by clusters”, “table of result and prediction of commodity sales by stores”, and “graphs of result and prediction of commodity sales by stores”, are displayed.

The “table of result and prediction of commodity sales by clusters” displays a numerical quantity result, a proceeds result, a numerical quantity prediction and a proceeds prediction of commodity sales of “∘Δ□× cookies 12 pieces” in regard to each of store clusters. The “graphs of result and prediction of commodity sales by clusters” display the total of the past sales of the “∘Δ□× cookies 12 pieces” and a time-sequential variation of predicted proceeds of future sales. In addition, as the predicted proceeds, both the predicted proceeds predicted based on the sales result of all stores, and the predicted proceeds predicted based on the sales proceeds of the stores belonging to a specific store cluster, are displayed.

The “table of result and prediction of commodity sales by stores” displays a numerical quantity result, a proceeds result, a numerical quantity prediction and a proceeds prediction of commodity sales of “∘Δ□× cookies 12 pieces” on a store-by-store basis. The “graphs of result and prediction of commodity sales by stores” display the total of the past sales of the “∘Δ□× cookies 12 pieces” and a time-sequential variation of predicted proceeds of future sales. In addition, as the predicted proceeds, both the predicted proceeds predicted based on the sales result of all stores, and the predicted proceeds predicted based on the sales result of a specific store, are displayed.

In this manner, in the process of step S208, the totalization items corresponding to the designation of the store, store cluster, store cluster label or commodity in step S207 are displayed. The totalization items displayed at this time are not limited to those in the examples of FIG. 10 to FIG. 12. For example, in consideration of easier viewing, only some totalization items among the totalization items displayed in FIG. 10 to FIG. 12 may be displayed, or totalization items different from those displayed in FIG. 10 to FIG. 12 may be displayed, or totalization items corresponding to the user's designation may be displayed. In addition, the information displayed on the graphs is not limited to the examples of FIG. 10 to FIG. 12. For example, in consideration of easier viewing, only a part of the information displayed on the graphs of FIG. 10 to FIG. 12 may be displayed, or information different from the information displayed in FIG. 10 to FIG. 12 may be displayed, or information corresponding to the user's designation may be displayed. For example, the “graphs of result and prediction of commodity sales” may display variations of the sales numerical quantity, instead of the variations of the sales proceeds.

### (Step S209)

In a case where a specific store cluster or store cluster label is designated, the user can input the name or information of the designated store cluster or store cluster label. At this time, by inputting the name or information of a store cluster label, a new store cluster label can also be created. The store cluster management unit 110 determines whether the name or information of a store cluster or store cluster label was input. In a case where the name or information of a store cluster or store cluster label was input, the process advances to step S210. In a case where the name or information of a store cluster or store cluster label is not input, the process advances to step S211.

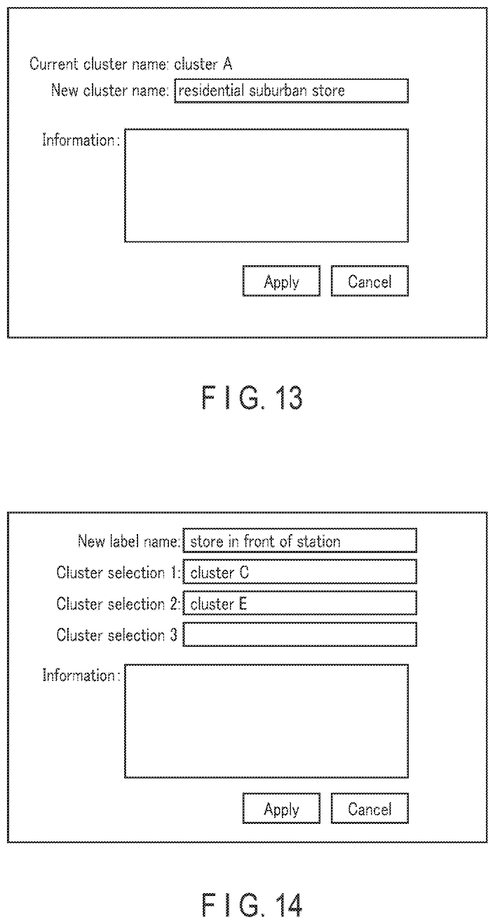

FIG. 13 is a view illustrating an example of a display screen that accepts an input of a name and information of a store cluster. In the example of FIG. 13, the user can input a new name of a designated store cluster in an input field of “new cluster name”. In addition, in the example of FIG. 13, the user can input a free description of information relating to the designated store cluster in an input field of “information”. Note that choices of typical input examples may be prepared in advance, and the information relating to a store cluster may be input by selecting one of the input examples.

FIG. 14 is a view illustrating an example of a display screen that accepts an input of a name and information of a new store cluster label. In the example of FIG. 14, the user inputs the name of a new store cluster label into an input field of “new label name”, and inputs IDs or names of store clusters into an input field of “cluster selection 1” to “cluster selection 3”, thus being able to freely set store clusters belonging to the store cluster label. The number of store clusters, which can be input, may be any number. In addition, the user can input a free description of information relating to the store cluster label into an input field of “information”. Note that choices of typical input examples may be prepared in advance, and the information relating to a store cluster label may be input by selecting one of the input examples.

### (Step S210)

The store cluster management unit 110 stores, in the store cluster label storage unit 111, the information that was input in the process of step S209. For example, if an input of a new name of a store cluster or store cluster label is accepted, the store cluster management unit 110 changes the current name to the input new name, and stores the changed name in the store cluster label storage unit 111.

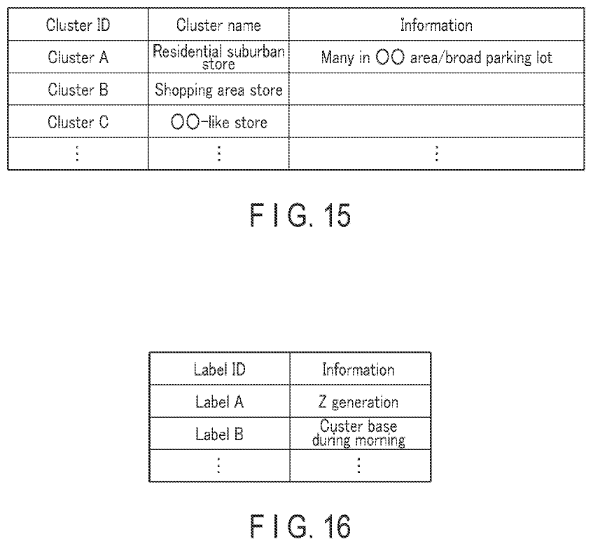

FIG. 15 is a diagram illustrating an example of store clusters stored in the store cluster label storage unit 111. In the example of FIG. 15, as a store cluster, columns of an ID (cluster ID) of a store cluster, a name (cluster name) of the store cluster, and information relating to the store cluster are stored in a table format.

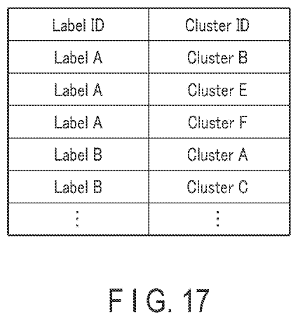

FIG. 16 and FIG. 17 are diagrams illustrating examples of store cluster labels stored in the store cluster label storage unit 111. In the example of FIG. 16, columns of an ID (label ID) of a store cluster label and information relating to the store cluster label are stored in a table format. In the example of FIG. 17, columns of an ID (label ID) of a store cluster label and an ID (cluster ID) of a store cluster belonging to the store cluster label are stored in a table format.

### (Step S211)

The user can change the designation of a store, a store cluster, a store cluster label, or a commodity. The store cluster display unit 109 accepts new designation by the user of the store, store cluster, store cluster label, or commodity.

### (Step S212)

In a case where the new designation is accepted, the process returns to step S208, and the store cluster display unit 109 changes the totalization result to be displayed on the display, in accordance with the change of designation.

In a case where new designation is not input, the purchase data analysis apparatus 100 terminates the clustering process. Note that the clustering process may be terminated in a case where an input to terminate the clustering process is accepted from the user.

### Advantageous Effects of the Embodiment

Hereinafter, the advantageous effects of the purchase data analysis apparatus 100 according to the present embodiment are described.

In the analysis of the purchase history data, it is required to classify a plurality of stores included in the purchase history data, into a plurality of store clusters composed of stores with similar characteristics. In the clustering method using the information such as a sales time, sales proceeds and commodity sales, the clustering result depends on merchandise assortment, stockout, sales methods, and the like. Thus, stores, which are similar in merchandise assortment or sales methods, are classified into an identical store cluster, and characteristics of customers are not reflected. In such a case, the accuracy of the analysis of sales prediction using the store cluster deteriorates.

In dealing with such a problem, the purchase data analysis apparatus 100 according to the present embodiment can acquire, on a customer-by-customer basis, customer information including an action time of a purchase-related action relating to purchase; generate, on a customer-by-customer basis, a customer representation representing an action pattern of a customer, based on the action time; generate, on a store-by-store basis, a store representation representing a representation of a customer coming to a store, based on the customer representation; and cluster stores by using the store representation. The customer information includes, for example, purchase history data for each customer. The customer information is, for example, ID-POS data, and is acquired from, for example, the purchase-related database 200. The customer representation represents, for example, an action pattern relating to a living habit or purchase of a customer. The customer representation includes, for example, a periodic explanatory variable, or an elapsed time from the entry into the store to the purchase-related action. Note that, as the customer representation, use may be made of values obtained by discretizing the explanatory variable or the elapsed time. The periodic explanatory variable is, for example, customer store-visiting patterns as illustrated in FIG. 3 and FIG. 4. In addition, the customer master data may further be acquired from the customer master 300, and the customer representation may be generated based on the customer information and the customer master data.

By the above configuration, according to the purchase data analysis apparatus 100 of the present embodiment, stores with similar characteristics can appropriately be clustered. For example, a customer store-visiting pattern representing the habit of purchase timing can be generated from the purchase history data on a customer-by-customer basis, a set of customer store-visiting patterns of customers can be acquired on a store-by-store basis, and store-visiting representations can be generated by totalizing the set. Since the thus generated store-visiting representation reflects the action pattern and habit of the customers, the store-visiting representation reflects the characteristics of the customer using the store. It is considered that the characteristics of the customer varies depending on the site location of the store and the manner of use of the store. Thus, the store-visiting representation reflects the characteristics of the customer due to the site location of the store and the manner of use of the store. Thus, by clustering the stores by using the store representations generated by using the customer-visiting patterns, it becomes possible to acquire store clusters reflecting the action patterns of customers and the characteristics of the habits of customers. In addition, even in regard to stores that differ in merchandise assortment, stockout and sales methods, stores with similar action patterns and habits of customers can be classified into an identical cluster, and it is thus possible to acquire a store cluster in which the influence of the merchandise assortment, stockout and sales methods of stores is reduced or eliminated. Thereby, a store cluster, in which not only the address information of stores but also the peripheral environments of stores are taken into account, can be acquired.

In addition, the purchase data analysis apparatus 100 according to the present embodiment can cluster customers, based on customer representations, and can cluster stores, based on the clustering result of customers. By using the clustering result of customers, store representations, in which representations of store-visiting customers are more reflected, can be generated.

Moreover, the purchase data analysis apparatus 100 according to the present embodiment can totalize customer information in regard to each of store clusters, based on the clustering result of stores, and can display the totalization result of customer information. For example, based on a sales result of a designated store cluster or a store cluster to which a designated store belongs, it is possible to execute a sales prediction of the designated store cluster or designated store. Thereby, by utilizing a sales result of other stores belonging to the same store cluster, a sales prediction for a commodity that has not been handled can be executed. Since sales results of stores with similar representations can be used, a sales prediction with high accuracy can be executed.

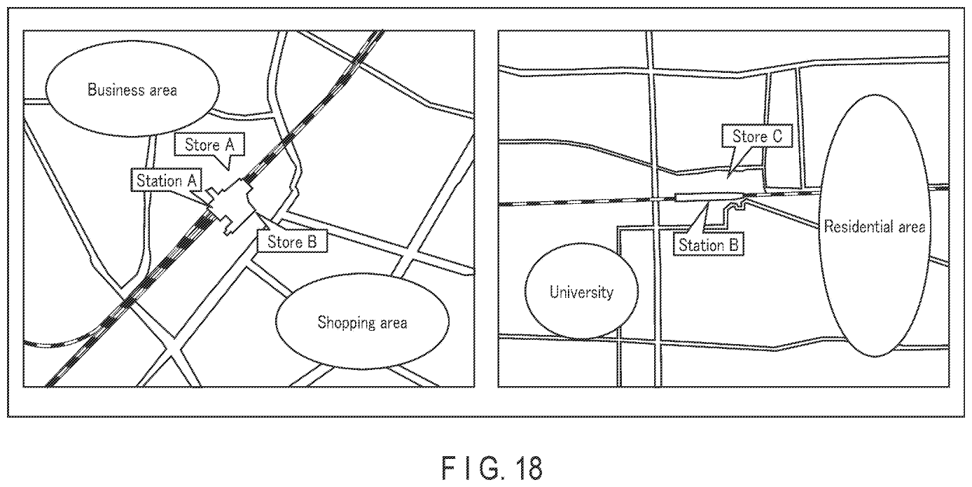

FIG. 18 is a diagram for concretely describing advantageous effects of the purchase analysis apparatus 100 of the present embodiment. FIG. 18 illustrates peripheral maps of a store A, a store B and a store C. It is assumed that the store A, store B and store C are stores of the same company. A station A and a station B are adjacent stations. The store A and store B neighbor the same station A, and have similar addresses and coordinates. However, since the store A and the store B are located on opposite sides in regard to the station A, while most of customers coming to the store A are users of a business area, most of customers coming to the store B are users of a shopping area, and the characteristics of the customers coming to these stores are different. Hence, the store A and the store B are different with respect to the merchandise assortment and the tendency of sales. Thus, even if a sales prediction of a commodity that is not currently handled in the store A is executed by using the sales result of the store B having a nearby address to the store B, the accuracy of the sales prediction becomes low.

In addition, since the characteristics of store-visiting customers are different between a store existing in a station yard and a store existing in a station building, it is considered that the tendency of sales is different between these stores. Besides, like the store A and the store C, in a case where the sizes and peripheral environments of adjacent stations are different, even if the addresses and coordinates of the stores are close, it is considered that the tendency of sales is different since the characteristics of store-visiting customers are different. In such a case, even if a sales prediction of a commodity that is not currently handled is executed by using the sales result of a store having a nearby address, the accuracy of the sales prediction becomes low.

On the other hand, in the present embodiment, stores are clustered by using the store-visiting pattern of store-visiting customers or the time until taking commodities in hands. It is considered that the differences in action patterns or habits of customers are reflected on the store-visiting pattern of store-visiting customers or the time until taking commodities in hands. Thus, by clustering stores by using the customer representations reflecting the differences in action patterns or habits of customers, it is possible to acquire such appropriate store clusters that stores with similar characteristics of store-visiting customers are classified into an identical cluster.

Note that an analysis result of stores can be utilized for an analysis of a company including one or more stores. In addition, in the present embodiment, although each process is executed on a store-by-store basis, each process may be executed on a company-by-company basis, instead of the store-by-store basis.

Furthermore, the purchase data analysis apparatus 100 according to the present embodiment can manage a store cluster label including one or more store clusters, can store the store cluster label, and can further execute totalization of customer information in regard to each of store cluster labels. According to this configuration, a store cluster label, which is a set of store clusters with similar representations, can be set, and totalization or analysis can be executed in regard to each of store cluster labels.

Additionally, the purchase data analysis apparatus 100 according to the present embodiment can accept an input of the name of a store cluster or a store cluster label, and can update the name of a store cluster or a store cluster label to the input name. Besides, the purchase data analysis apparatus 100 according to the present embodiment can further accept an input of information of a store cluster or a store cluster label. The user can freely change the name or content of the store cluster label.

### (Modifications)

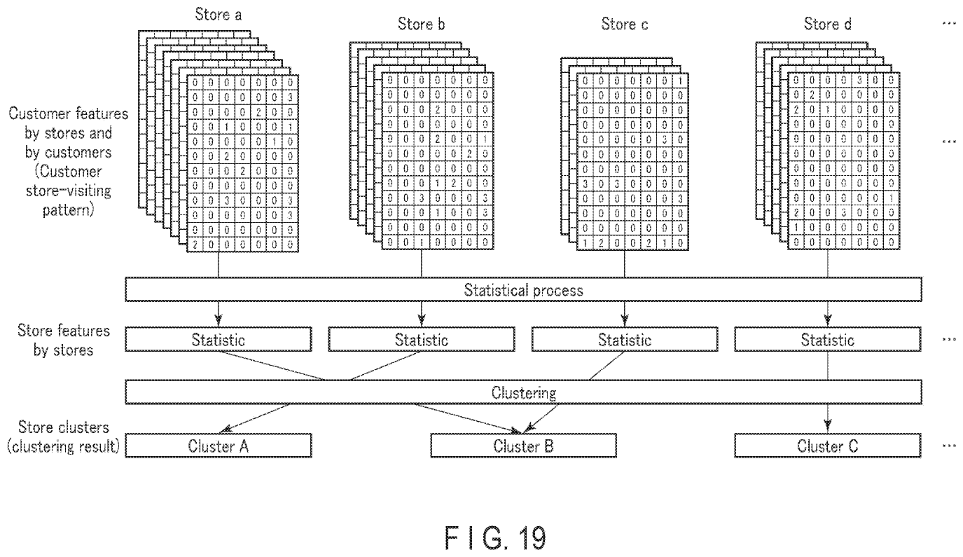

In the above-described embodiment, the purchase data analysis apparatus 100 executes two-time clustering, namely a clustering of classifying customers into customer clusters, and a clustering of classifying stores into store clusters, but the clustering for customers may be omitted. In this case, the customer clustering unit 103 and the customer cluster data storage unit 104 can be omitted. The store representation generation unit 105 calculates a statistic of the customer representations and uses the statistic as a store representation, instead of generating a store representation by using the clustering result of customers using customer representations. As the statistic, for example, an average value, variance or the like can be used. FIG. 19 is a schematic diagram schematically illustrating a process of generating store clusters in a clustering process according to a modification. Note that an arithmetic operation result using a plurality of statistics may be used as a store representation.

### Applied Example

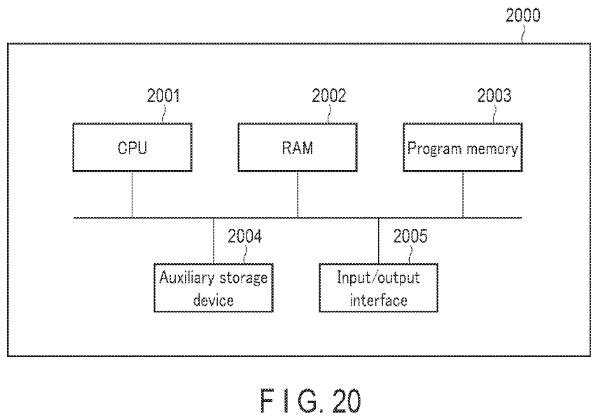

FIG. 20 is a block diagram exemplarily illustrating a hardware configuration of a purchase data analysis apparatus 2000 according to an applied example. The applied example is a concrete example of the embodiment and each modification, and is a mode in which the purchase data analysis apparatus 2000 is implemented by a computer.

The purchase data analysis apparatus 2000 includes, as hardware, a CPU (Central Processing Unit) 2001, a RAM (Random Access Memory) 2002, a program memory 2003, an auxiliary storage device 2004, and an input/output interface 2005. The CPU 2001 communicates with the RAM 2002, program memory 2003, auxiliary storage device 2004 and input/output interface 2005 via a bus. Specifically, the purchase data analysis apparatus 2000 of the present embodiment is implemented by a computer having such a hardware configuration.

The CPU 2001 is an example of a general-purpose processor. The RAM 2002 is used by the CPU 2001 as a working memory. The RAM 2002 includes a volatile memory such as an SDRAM (Synchronous Dynamic Random Access Memory). The program memory 2003 stores a data analysis program for implementing components corresponding to each embodiment. The data analysis program may be, for example, a program for causing a computer to implement the functions of the customer information acquisition unit 101, customer representation generation unit 102, customer clustering unit 103, customer cluster data storage unit 104, store representation generation unit 105, store clustering unit 106, store cluster data storage unit 107, store cluster totalization unit 108, store cluster display unit 109, store cluster management unit 110, and store cluster label storage unit 111. In addition, as the program memory 2003, for example, a ROM (Read-Only Memory), a part of the auxiliary storage device 2004, or a combination thereof is used. The auxiliary storage device 2004 stores data in a non-transitory manner. The auxiliary storage device 2004 includes a nonvolatile memory such as an HDD (hard disk drive) or an SSD (solid state drive).

The input/output interface 2005 is an interface for a connection to other devices. The input/output interface 2005 is used, for example, for a connection to a keyboard, a mouse, a database and a display.

The data analysis program stored in the program memory 2003 includes a computer-executable instruction. The data analysis program (computer-executable instruction), if executed by the CPU 2001 that is processing circuitry, causes the CPU 2001 to execute a predetermined process. For example, the data analysis program, if executed by the CPU 2001, causes the CPU 2001 to execute a series of processes described in connection with the respective components of FIG. 1. For example, the computer-executable instruction included in the data analysis program, if executed by the CPU 2001, causes the CPU 2001 to execute a data analysis method. The data analysis method may include steps corresponding to the functions of the above-described customer information acquisition unit 101, customer representation generation unit 102, customer clustering unit 103, customer cluster data storage unit 104, store representation generation unit 105, store clustering unit 106, store cluster data storage unit 107, store cluster totalization unit 108, store cluster display unit 109, store cluster management unit 110, and store cluster label storage unit 111. Furthermore, the data analysis method may include the steps illustrated in FIG. 2, as appropriate.

The data analysis program may be provided to the purchase data analysis apparatus 2000 that is a computer, in a state in which the data analysis program is stored in a computer-readable storage medium. In this case, for example, the purchase data analysis apparatus 2000 further includes a drive (not illustrated) that reads out data from the storage medium, and acquires the data analysis program from the storage medium. As the storage medium, for example, a magnetic disk, an optical disc (CD-ROM, CD-R, DVD-ROM, or DVD-R), a magneto-optical disc (MO, or the like), or a semiconductor memory can be used as appropriate. The storage medium may be called a non-transitory computer-readable storage medium. In addition, the data analysis program may be stored in a server on a communication network, and the purchase data analysis apparatus 2000 may download the data analysis program from the server by using the input/output interface 2005.

The processing circuitry that executes the data analysis program is not limited to general-purpose hardware such as the CPU 2001, and a purpose-specific hardware processor such as an ASIC (Application Specific Integrated Circuit) may be used. The term “processing circuitry (processing unit)” includes at least one general-purpose hardware processor, at least one purpose-specific hardware processor, or a combination of at least one general-purpose hardware processor and at least one purpose-specific hardware processor. In the example illustrated in FIG. 20, the CPU 2001, RAM 2002 and program memory 2003 correspond to the processing circuitry.

Thus, according to any one of the above-described embodiments, there can be provided a purpose data analysis apparatus, method and program, which can appropriately cluster stores with similar characteristics.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A purchase data analysis apparatus comprising processing circuitry, the processing circuitry being configured to:
acquire, on a customer-by-customer basis, customer information including an action time of a purchase-related action relating to purchase;
generate, on a customer-by-customer basis, a customer representation representing an action pattern of a customer, based on the action time;
generate, on a store-by-store basis, a store representation representing a representation of a customer coming to a store, based on the customer representation; and
cluster stores by using the store representation.

2. The purchase data analysis apparatus of claim 1, wherein the processing circuitry is further configured to acquire customer master data, and generate the customer representation, based on the customer information and the customer master data.

3. The purchase data analysis apparatus of claim 1, wherein the customer representation includes a periodic explanatory variable, an elapsed time from an entry to the store to the purchase-related action, a value obtained by discretizing the explanatory variable, or a value obtained by discretizing the elapsed time.

4. The purchase data analysis apparatus of claim 1, wherein the processing circuitry is configured to cluster the customers, based on the customer representations, and clusters the stores, based on a clustering result of the customers.

5. The purchase data analysis apparatus of claim 1, wherein the processing circuitry is configured to execute totalization of the customer information in regard to each of store clusters, based on a clustering result of the stores, and displays a totalization result of the customer information.

6. The purchase data analysis apparatus of claim 5, wherein the processing circuitry is configured to execute, based on a sales result of a designated store cluster or a store cluster to which a designated store belongs, a sales prediction of the designated store cluster or the designated store.

7. The purchase data analysis apparatus of claim 5, further comprising a store cluster storage unit configured to store a store cluster label,
wherein the processing circuitry is configured to manage a store cluster label including one or more of the store clusters, and further executes totalization of the customer information in regard to each of the store cluster labels.

8. The purchase data analysis apparatus of claim 7, wherein the processing circuitry is configured to accept an input of a name of the store cluster or the store cluster label, and updates a name of the store cluster or the store cluster label to the input name.

9. The purchase data analysis apparatus of claim 8, wherein the processing circuitry is further configured to accept an input of information of the store cluster or the store cluster label.

10. A method comprising:
acquiring, on a customer-by-customer basis, customer information including an action time relating to purchase;
generating, on a customer-by-customer basis, a customer representation representing an action pattern of a customer, based on the action time;
generating, on a store-by-store basis, a store representation representing a representation of a customer coming to a store, based on the customer representation; and
clustering stores by using the store representation.

11. A non-transitory computer-readable storage medium storing a program for causing a computer to execute:
a function of acquiring, on a customer-by-customer basis, customer information including an action time relating to purchase;
a function of generating, on a customer-by-customer basis, a customer representation representing an action pattern of a customer, based on the action time;
a function of generating, on a store-by-store basis, a store representation representing a representation of a customer coming to a store, based on the customer representation; and
a function of clustering stores by using the store representation.
